(19) United States
(12) Patent Application Publication
(10) Pub. No.: US 2008/0263948 A1
(43) Pub. Date: Oct. 30, 2008

(54) PLANT POT AND SOIL WATERING SYSTEM

(76) Inventor: Jean Caron, St-Romuald (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/171,688

(22) Filed: Jul. 11, 2008

Related U.S. Application Data
(62) Division of application No. 10/496,304, filed on Jun. 2, 2004.
(60) Provisional application No. 60/341,787, filed on Dec. 21, 2001.

(51) Int. Cl. A01G 27/06

(52) U.S. Cl. 47/80; 47/48.5

(57) ABSTRACT

An irrigation system for watering a substrate, comprising a pipe having a longitudinal dimension. A hermetically closeable inlet portion is connected to a water supply. A passageway extends generally throughout the longitudinal dimension and is in fluid communication with the inlet portion such that water can fill the passageway. Openings are in fluid communication with the passageway such that water in the passageway can exit the pipe through the openings. The openings are distributed along the longitudinal dimension of the pipe, the pipe being adapted to be at least partially buried in the substrate with said longitudinal dimension being generally horizontal. Porous members are secured to an outer periphery of the pipe so as to each cover one of the openings and so as to be in contact with the substrate such that water flows out of the passageway through the openings and the porous member and into the substrate as a result of a capillary action of the substrate.

### CROSS-REFERENCE TO RELATED APPLICATIONS

This application is a Divisional of U.S. patent application Ser. No. 10/496,304 filed on Jun. 2, 2004 which claims benefit of International Patent Application No. PCT/CA02/01993, filed on Dec. 20, 2002, which claims benefit of U.S. Provisional Patent Application No. 60/341,787, filed Dec. 21, 2001.

BACKGROUND OF THE INVENTION

1. Field of the Invention

The present invention relates to plant pot watering systems and irrigation systems and, more particularly, to systems for controlling the level of irrigation.

2. Description of the Prior Art

In potted plant production, irrigation is often a problem, as the stored water volume within a plant pot is rapidly depleted as the plant grows, and thus the plant needs to be regularly monitored and watered by workers. Such a process is both very expensive as well as time consuming. In addition, no plant pot irrigation monitoring system is currently available which is accurate enough to take into account the fact that different plants, or the same plants at different growth stages, have different cycles of growth, and therefore different rates of water consumption. Therefore, there is a need for a plant pot and soil watering system which maintains a constantly available water supply and which diminishes watering frequency. There is also a need for a system which permits salt leaching. A problem frequently associated with prior art plant pot devices using capillary action to drive the water into the substrate is that very little leaching is possible due to the inherent design of the system. Furthermore, there is a need for a system which permits steam sterilization to prevent and limit the spread of disease from the substrate which supports the plant.

### SUMMARY OF THE INVENTION

It is an object of the present invention to overcome, or substantially overcome, the disadvantages of the prior art.

It is another object of the invention to provide a plant pot which stores a volume of water for ready usage, and which dispenses water to the plant in a regular metered fashion.

It is another object of the invention to provide a plant pot which contains a porous medium, such that dispensing of the water is controlled by capillary movement, and air entry principles.

it is a further object of the invention to provide a plant pot which permits both salt leaching and steam sterilization.

According to the invention, there is provided a plant pot which contains a fluid supply reservoir on the periphery of the pot. The fluid supply reservoir is in fluid communication, with an external source, or can be filled manually by removing a stopper which covers a opening at the top portion of the pot. The fluid supply reservoir defines a wall within the inner portion of the pot, and lower portion of this wall contains a porous membrane which permits fluid communication between the fluid supply reservoir and the inner portion of the pot. The fluid thus communicates with a substrate contained within the pot, and is controlled by capillary action, which is facilitated by an air entry tube near the base of the pot, or by the porous membrane which permits the fluid to flow from the fluid supply reservoir to the water absorbent substrate. Drainage holes in the bottom portion of the pot permit an excess of water to be drained, and thus maintain an appropriate water supply within the porous substrate supporting the plant. The present invention also defines a dripper which permits fluid from the fluid reservoir to drip on to the plant supporting substrate so as to permit salt leaching, and prevent the build up of harmful salts within the substrate.

Therefore, in accordance with the present invention, there is provided a device for watering a substrate, comprising: a reservoir having a cavity for receiving water therein, a hermetically closeable inlet portion in fluid communication with the cavity for filling the cavity with water, and an outlet portion in fluid communication with the cavity, the reservoir being adapted to be positioned such that the outlet portion is buried by the substrate; and a porous member received in the outlet portion so as to be in contact with the substrate such that water flows out of the cavity through the porous member and into the substrate as a result of a capillary action of the substrate to create a negative pressure differential between the cavity and the substrate, the porous member having pores ranging between 10 and 600 micrometers in size to cause a flow of water from the cavity to the substrate as a function of a given value of said negative pressure differential.

The negative pressure differential at which air enters into the cavity is a function of the pore size of the porous member, and this results in a volume of water flowing form the cavity to the substrate.

Further in accordance with the present invention, there is provided an irrigation system for watering a substrate, comprising a pipe having a longitudinal dimension, a hermetically closeable inlet portion adapted to be connected to a water supply, a passageway extending generally throughout the longitudinal dimension and in fluid communication with the inlet portion such that water can fill the passageway, and openings in fluid communication with the passageway such that water in the passageway can exit the pipe through the openings, the pipe being adapted to be at least partially buried in the substrate with the openings facing downwardly, and at least one porous member secured to an outer periphery of the pipe so as to cover the openings and be in contact with the substrate such that water flows out of the passageway through the openings and the porous member and into the substrate as a result of a capillary action of the substrate.

BRIEF DESCRIPTION OF THE DRAWINGS

In order that the invention may be more readily understood and put into practical effect, reference will be made to the accompanying drawings, in which:

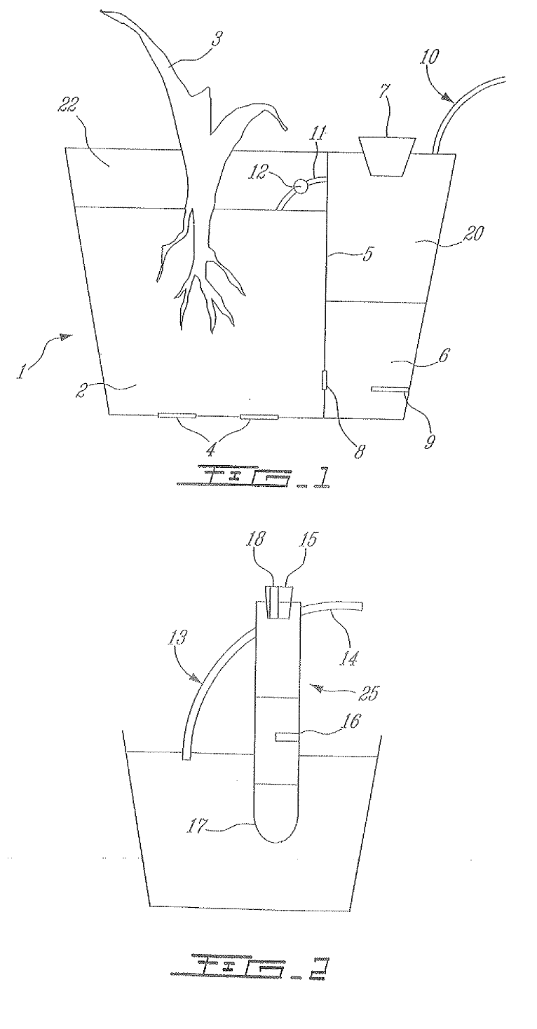

FIG. 1 is a side view of the plant pot of the present invention;

FIG. 2 is a side view of a variant embodiment having an independent water supply;

FIG. 3 is a schematic cross sectional view of an irrigation system in accordance with the present invention;

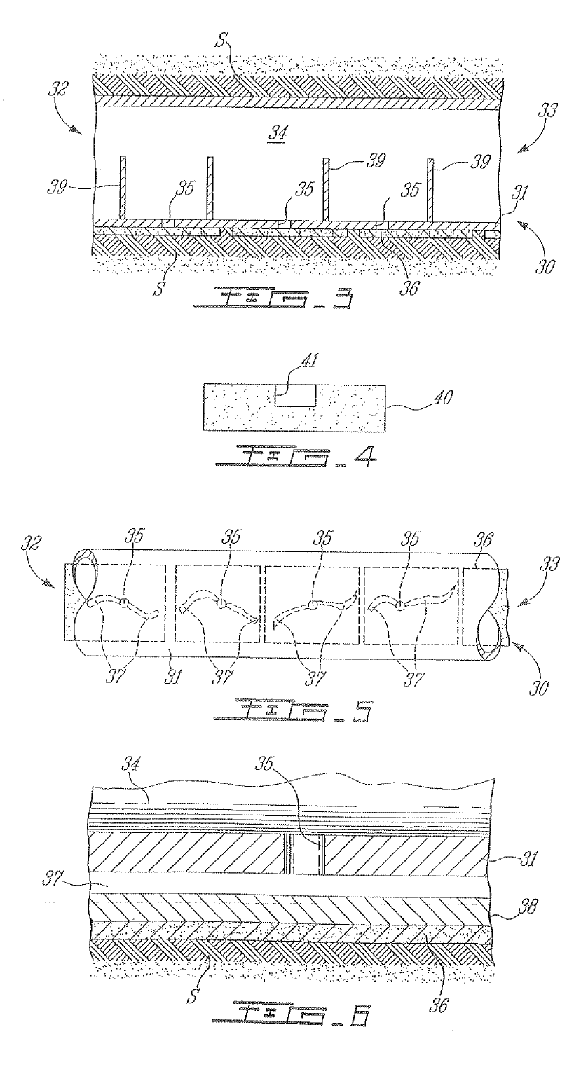

FIG. 4 is a schematic cross-sectional view of a porous cup to be used with the irrigation system;

FIG. 5 is a schematic bottom plan view of the irrigation system with a porous membrane removed; and

FIG. 6 is an enlarged cross sectional view of a portion of the irrigation system.

### DESCRIPTION OF THE PREFERRED EMBODIMENTS

Reference is made to FIG. 1, which discloses a plant pot 1. This plant pot may be any conventional plant pot 1, having any known shape, and constructed from materials well known to one of ordinary skill in the art. Contained within the plant pot is a dividing wall 5, which defines an outer fluid reservoir 20 separate from an internal portion 22 of the plant pot. At the top portion of the outer fluid reservoir 20 is an opening closed by a stopper 7 which, when removed, permits either filling or emptying of the outer fluid reservoir 20. An external water supply hose 10 connects to the outer fluid reservoir 20 so as to fill the reservoir 20 with the appropriate fluid when desired. It is pointed out that the stopper 7 is optional for filling the outer fluid reservoir 20 as this may be executed through the external water supply hose 10. On the lower portion of the dividing wall 5 is a porous membrane 8 which permits fluid communication between the fluid reservoir 20 and the internal portion 22 of the plant pot 1. An air entry hole 9 is optionally provided to communicate ambient air to the outer fluid reservoir 20. This air entry hole 9 can be used to control the suction (i.e., negative pressure differential between the outer fluid reservoir 20 and the substrate 2) within the outer fluid reservoir 20, to ensure a continual flow of water from the outer fluid reservoir 20 to the internal portion 22 of the plant pot 1. This flow of water occurs when the suction in the substrate 2 becomes temporarily greater than that in the outer fluid reservoir 20.

Contained within the internal portion 22 of the plant pot 1 and externally of the outer fluid reservoir 20 is a plant supporting substrate 2 which supports a growing plant 3, and which typically includes plant roots at its lower end. Fluid from the outer fluid reservoir 20 is drawn to the plant roots through the porous membrane 8, and as a result of the capillary action created by the air entry hole 9, porous membrane 8, and porous substrate 2. At the time of filling, positive pressure may exist within the reservoir and excess fluid thus flows through the porous membrane 8. Any excess fluid which is drawn into the internal portion 22 of the plant pot 1 is drained away by drainage holes 4 at the lower end of the plant pot l.

As the outer fluid reservoir 20 is airtight aside from the porous membrane 8, the suction exerted by the substrate 2 on the water 6 of the outer fluid reservoir 20 will create a negative pressure in the outer fluid reservoir 20. It is pointed out that the porous membrane 8 will be saturated with water blocking the pores, during the transfer of water from the reservoir 20 to the substrate 2.

The negative pressure in the reservoir 20 will reach an equilibrium with the capillary suction of the substrate 2, at which point air in the substrate 2 will be sucked into the reservoir 20 to continuously balance the pressure differential between the reservoir 20 and the substrate 2. The air passing through the pores to reach the reservoir 20 will free the pores, at least momentarily, to let water transfer from the reservoir 20 to the substrate 2. The pressure differential between the outer fluid reservoir 20 and the substrate 2 is a function of the pore size of the porous membrane 8, and the air entry in the outer fluid reservoir 20 occurs at a constant pressure differential. It has been experimentally determined that the suction exerted on the substrate of a pot is preferably maintained between 0.5 and 10.0 kPa, with an average of about 5 kPa. For such a range of suction to be attained, the porous membrane 8 must have pores ranging between 30 and 600 micrometers, with the greater pore sizes being matched with suction of lower magnitudes.

For cultivation fields, the suction exerted on the substrate is preferably maintained between 5.0 and 30.0 kPa. Corresponding pore size of a porous membrane appropriate for this range goes from 10 to 60 micrometers. Once more, there is an inversely proportional relation between the magnitude of suction pressure and the pore size of the porous membrane.

Examples of materials used for the porous membrane 8 include clay, porous rocks/stones and nylon membranes. Also, various fritted materials having a suitable porosity (e.g., equivalent to the pore sizes described previously) can be used. The nylon membranes are typically used with a geotextile membrane that helps redistributing water, while the nylon membrane also acts to protect the geotextile from root penetration.

The air entry hole 9 is typically a pin hole (and there can be a plurality of such pin holes) which is optionally provided to enhance the water flow from the reservoir 20 to the substrate 2. As a result of the small area of the air entry hole 9, a slight compensation is performed by air entering therethrough when water flows from the reservoir 20 to the substrate 2. In embodiments where a positive pressure differential must be created between the reservoir 20 and the substrate 2, as will be described below, the reservoir 20 must be exempt of any such air entry hole 9.

The plant pot 1 also optionally includes a dripper 11, and a closeable, one-way flow valve 12 in fluid communication with the dripper 11, which allows a leaching solution (e.g., water) from the outer fluid reservoir 20 to flow to the substrate 2. The dripper 11 is connected at one end to the outer fluid reservoir 20 and at its opposite end to the plant supporting substrate 2. The purpose of the dripper 11 is to permit a leaching of salt accumulations from the substrate 2, and thus prevent a build up of such salts in the area of the substrate 2 which contacts the plant roots. As a first alternative embodiment (not shown), the leaching can be carried out by filling the outer reservoir 20 with an external supply of leaching solution incoming from either the external water supply hose 10 or from a manual, fill through the opening that is selectively closed by the stopper 7. A positive pressure in the outer fluid reservoir 20 will cause a flow of leaching solution to the substrate 2. The leaching solution may be water, or other liquid substances known in the art which are capable of leaching salt and salt solutions from substrate. For such an embodiment, the reservoir 20 must be exempt of any such air entry hole 9.

In a second alternative embodiment (not shown), the dripper 11 can be replaced with a series of external drippers connecting an external supply of leaching solution, with the internal portion 22 of the plant pot 1. The plant pot 1 of the present invention also may utilize steam, for the purposes of preventing the spread of disease from potted substrates. Steam can be introduced from an external source and into the supply hose 10, while the one-way valves on the drippers are maintained closed, resulting in the introduction of steam into the outer fluid reservoir 20 and into the plant supporting substrate 2 via the porous membrane 8. Steam may also be introduced through mechanisms independent of the plant pot 1 itself, or by such means as known to one of ordinary skill in the art. For such an embodiment, the reservoir 20 must be exempt of any such air entry hose 9.

The fluid supply reservoir can be made independently of the pot itself, such as tube-shaped reservoir 25 in FIG. 2 or as irrigation system 30 illustrated in FIGS. 3 to 6. The reservoir 25 is an independent water supply that is made of any impermeable material and can have various configurations. The reservoir 25 has a porous membrane 17 that respects the above described criteria of pore size and material for a generally constant air entry therethrough. The reservoir 25 still can have a dripper with a one-way valve 13, an external water supply 14, a stopper 15 and an optional air entry 16. Some of these items are facultative though as the system can operate with the porous membrane 17 and the stopper only 15. The stopper 15 can be equipped with a one-way stop valve 18 which allows filling the water supply reservoir 25 externally by hand or with any watering device having a pressure high enough to displace the valve 18, thereby filling the reservoir. The independent water supply system will function exactly as that described in. FIG. 1.

A plurality of the reservoirs 25 can be interconnected by a network of water supplies 14. Therefore, a single water source could feed all reservoirs 25, for instance each positioned in a different plant pot, to greatly reduce watering logistics. Alternatively, such a system can be used in a cultivation field to supply water to different locations.

Referring to FIGS. 3 to 6, an irrigation system 30 is illustrated and is an alternative embodiment to the network of reservoirs 25. The irrigation system 30 is conceived for being used in cultivation fields. The irrigation system 30 consists of a pipe 31. In FIG. 3, a segment of the pipe 31 is illustrated, and the pipe 31 is substantially longer than that segment. The pipe 31 is shown buried in a substrate or soil S.

The pipe 31 has an inlet end 32 and an outlet end 33, and defines a passageway 34 such that fluid can be conveyed from the inlet end 32 to the outlet end 33. Openings 35 are defined in a bottom portion of the pipe 31 and are spaced from one another on the full length, of the pipe 31. Fluid in the passageway 34 can exit the pipe 31 through the openings 35. Preferably, the pipe 31 is semi-rigid, whereby its flexibility will be used to create various patterns in the soil S.

Porous membranes 36 are secured to the bottom portion of the pipe 31 so as to separate the openings 35 from the soil S. The porous membranes 36 follow the above-described criteria of pore size and material for a generally constant air entry value within the pipe. The porous membranes 36 mold the bottom portion of the pipe 31, on the full length of the pipe 31, and are preferably separated from one another, so that water can flow through each opening 35 independently (as opposed to a single porous membrane running the length of the pipe 31).

The irrigation system 30 is used in similar fashion to the fluid reservoir 20 of FIG. 1 and the reservoir 25 of FIG. 2. Namely, once the pipe 31 is buried in the soil S, the passageway 34 is filled with water and the inlet end 32 and outlet end 33 are sealed. The soil S will exert a capillary pressure on the water of the passageway 34, whereby a negative pressure will be created in the passageway 34 as water exits therefrom. At a point of equilibrium, air will free the saturated pores to cause, a constant water/air exchange.

It is possible to increase a rate of water/air exchange by providing grooves 37, as illustrated in FIGS. 5 and 6, on an outer periphery of the pipe 31 and in fluid communication with the openings 35, and a geotextile 38. The grooves 37 and the geotextile 38 will increase the flow of water from the passageway 34 to the porous membrane 36, preferably a nylon membrane in this case. The geotextile 38 must be fully covered by the porous membrane 36 along its length so as to be sandwiched between the porous membrane 36 and the outer periphery of the pipe 31. The porous membrane 36 will protect the geotextile 38 from root penetration.

Preferably, the passageway 34 is provided with rigid dividers 39 between each adjacent pair of openings 35. The dividers 39 will ensure that water is supplied to substantially every opening 35 in the event that the pipe 31 must be slanted with respect to the horizon.

Referring to FIG. 4, an alternative embodiment to the porous membrane 36 is illustrated. A porous cup 40 has a hole 41 that is positioned opposite one of the openings 35 so as to receive water therefrom. The porous cup 40 is disc shaped, and does not affect the flexibility of the pipe 31, as adjacent cups 4 0 are independent from one another.

The foregoing description of the preferred embodiments of the invention has been presented for the purposes of illustration and description. It is not intended to be exhaustive, or to limit the invention to the precise form disclosed. It is intended that the scope of the invention be limited not by this detailed description, but rather by claims appended hereto.

I claim:

1. A method for passively regulating water delivery to a plant growing substrate, the method comprising:
a) providing a pipe-like reservoir having a plurality of outlet openings distributed along a length thereof, said outlet openings being covered by at least one capillary porous member;
b) filling said pipe-like reservoir with water;
c) hermetically closing the pipe-like reservoir but for said plurality of outlet openings,
d) interfacing said at least one capillary porous member with said substrate, the capillary porous member and the substrate creating a capillary interface between the substrate and the water in the hermetically closed pipe-like reservoir; and
e) using a capillary action of said substrate on the water in the hermetically closed pipe-like reservoir to draw water out of the pipe-like reservoir into the substrate, the negative pressure differential between the pipe-like reservoir and the substrate regulating the amount of water drawn from the pipe-like reservoir by the substrate.

2. The method defined in claim 1, wherein said capillary porous member has pores, and wherein the method comprises selecting the size of the pores to range between 10 and 60 micrometers.

3. The method defined in claim 1, comprising selectively opening an air entry hole in the pipe-like reservoir ho control the negative pressure differential, between the pipe-like reservoir and the substrate.

4. The method defined in claim 1, wherein step d) comprises burying the hermetically closed pipe-like reservoir in the substrate.

5. The method defined in claim 1, wherein step a) comprises providing localised flow control along the hermetically closed pipe-like reservoir by covering said outlet openings with individual capillary porous members separated from one another, each said individual capillary porous member being provided in the form of a porous cup having a hole positioned opposite an associated one of the outlet openings of the pipe-like reservoir.

6. The method defined in claim 1, wherein step a) comprises providing an additional layer of capillary material between the pipe-like reservoir and the at least one capillary porous member.

7. The method defined in claim 1, wherein step a) comprises defining in. an outer wall surface of the pipe-like reservoir a plurality of peripheral grooves, each peripheral groove extending longitudinally from opposed sides of an associated one of the outlet openings, and covering the grooves with the at least one capillary porous member.

8. The method defined in claim 1, wherein the outlet holes are solely defined in a bottom surface of the pipe-like reservoir, and wherein step a) further comprises providing a divider in the pipe like-reservoir between each pair of adjacent ones of said outlet openings.

9. The method defined in claim 1, wherein step e) comprises saturating said at least one capillary porous member with water until a point of equilibrium is reached with the capillary suction of the substrate, at which point air in the substrate is sucked into the pipe-like reservoir to cause a regulated water/air exchange between the substrate and the water in the pipe-like reservoir.

10. An irrigation system for passively regulating water delivery to plants, the system comprising a plant growing substrate, a pipe-like reservoir at least partly buried in the plant growing substrate and defining a negative pressure chamber filled with water and sealed from the atmosphere, a plurality of outlet holes distributed along said closed pipe-like reservoir, said outlet holes being in fluid flow communication with said negative pressure chamber, at least one capillary porous member covering said outlet holes, the substrate and the capillary porous member cooperating to provide a capillary interface between the substrate and the negative pressure chamber, the substrate and the capillary porous member maintaining the chamber under a negative pressure and the substrate drawing water out of the negative pressure chamber through said outlet holes and said at least one porous member, the capillary interface allowing air to flow from the substrate into the negative pressure chamber as water flows out of the chamber, thereby continuously balancing the pressure differential between the negative pressure chamber and the substrate.

11. The irrigation system defined in claim 10, wherein said negative pressure chamber extends substantially horizontally between hermetically closed ends which are substantially levelled with respect to one another, said plurality of outlet holes constituting a sole exchange interface of said negative pressure between said hermetically closed ends.

12. The irrigation system defined in claim 10, wherein said outlet holes are generally aligned in the longitudinal direction of the pipe-like reservoir and solely defined in a bottom surface thereof, and further comprising dividers in the negative pressure chamber between each pair of adjacent ones of the outlet holes.

13. The irrigation system according to claim 10, further comprising a capillary material disposed between the capillary porous member and the outer periphery of the pipe-like reservoir.

14. The irrigation system according to claim 10, wherein the at least one capillary porous member comprises a plurality of cups, with each one of said cups having a hole aligned with an associated one of the outlet holes.

15. The irrigation system according to claim 10, wherein peripheral grooves extends from opposed sides of each out Jet holes in a bottom outer surface of the pipe-like reservoir, the peripheral grooves being covered by the at least one capillary porous member.
